(19) United States
(12) Patent Application Publication
(10) Pub. No.: US 2013/0239313 A1
(43) Pub. Date: Sep. 19, 2013

(54) BALL-SHAPED TOILET BLOCKS BASED ON ANIONIC SURFACTANTS

(71) Applicant: Henkel AG & Co. KGaA, Duesseldorf (DE)

(72) Inventors: Marc-Steffen Schiedel, Monheim (DE); Brigitte Giesen, Duesseldorf (DE); Anke Ernst, Leichlingen (DE); Christian Reichert, Duesseldorf (DE); Robert Stephen Cappleman, Duisburg (DE); Michael Horn, Duesseldorf (DE)

(73) Assignee: Henkel AG & Co. KGaA, Duesseldorf (DE)

(21) Appl. No.: 13/890,837

(22) Filed: May 9, 2013

Related U.S. Application Data
(63) Continuation of application No. PCT/EP2011/069965, filed on Nov. 11, 2011.

(30) Foreign Application Priority Data
Nov. 12, 2010 (DE) 10 2010 043 848.0

(51) Int. Cl. C11D 17/00; E03D 9/00

(52) U.S. Cl. CPC C11D 17/0056; E03D 9/005
USPC 4/222; 510/192; 264/145

(57) ABSTRACT

A toilet cleaning block which comprises perfume, at least one alkylbenzene sulfonate and at least one olefin sulfonate and not more than 2.5% by weight of nonionic surfactants can be shaped in a rolling machine or a press to give a rotationally symmetric body, especially to give a ball, and is employed in a system composed of at least one cleaning block and at least one release device.

### FIELD OF THE INVENTION

The present invention generally relates to a toilet cleaning block, which comprises perfume, at least one alkylbenzene sulfonate and at least one olefin sulfonate as well as at least one further anionic surfactant, and which can be shaped in a rolling machine or press to form a rotationally symmetrical, in particular spherical object, and also to a method of manufacturing it and to a system composed of at least one such toilet cleaning block and a dispensing device.

### BACKGROUND OF THE INVENTION

Toilet cleaning cakes, also known as toilet blocks, have already been used for a long time for cleaning, disinfecting and perfuming toilets under the rim of the bowl (so-called rim blocks) and in the water cistern (in-tank blocks or cistern blocks). In recent years, esthetics and performance have gained increasing importance. This has led, for instance, to the development of fresheners in liquid or gel form, which in some cases are offered for sale in multi-chamber containers, thus enabling a cleaning agent, which is released when the toilet is flushed, to be combined with permanent room perfuming.

Solid toilet blocks also remain relevant, however. Up to the present, these have been manufactured predominantly by extrusion and then cut to size, so that mainly rectangular toilet rim blocks were obtained which were then employed in appropriate cages.

A disadvantage of these rim blocks is that they swell as a result of the flushing water flowing into the cage, causing them to be flushed away unevenly and to lose their shape. Even after a short period, an unaesthetic block therefore remains.

Another aspect which is experiencing increasing importance in the toilet sector is hygiene. There is increasing consumer demand for products which have a disinfecting action as well as a cleaning action. For solid toilet blocks, chlorine carriers are among the suitable disinfectants, but these cannot be incorporated into every formulation in a stable manner. In the composition known from DE 102009003088, for instance, which comprises a perfume, at least one nonionic surfactant together with at least one alkylbenzene sulfonate and at least one olefin sulfonate, with the additional use of a chlorine-containing disinfectant such as dichloroisocyanurate, a marked reduction in the chlorine content is recorded soon after manufacture, and after a relatively short period of use the chlorine content can only be detected in traces.

It was therefore desirable to formulate an esthetic toilet block in a pleasing shape, which is flushed away evenly throughout its total life span and swells as little as possible. At the same time, it should be possible to incorporate antimicrobial active ingredients, in particular chlorine-containing disinfectants, in a stable manner.

Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

A toilet cleaning block comprising perfume, at least one alkylbenzene sulfonate and at least one olefin sulfonate, wherein the block comprises one or more antimicrobial active ingredients and no more than 2.5 wt. % nonionic surfactants and is shaped in a rolling machine or press to form a spherical object.

A method of manufacturing a rotationally symmetrical toilet cleaning block which comprises perfume, alkylbenzene sulfonate and olefin sulfonate and is free from nonionic surfactants, encompassing the steps of: mixing the ingredients, extruding the mixture, cutting the extruded strand into pieces of a defined mass, and shaping into rotationally symmetrical objects.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

Surprisingly, it has now been found that a formulation which comprises perfume, at least one alkylbenzene sulfonate and at least one olefin sulfonate and no more than 2.5 wt. % nonionic surfactants permits the stable incorporation of even chlorine-containing antimicrobial active ingredients. These toilet blocks do not swell and, because of their round shape, they always display a minimum surface area. They are therefore flushed away evenly, so that the original shape is retained even after many flushes.

The invention therefore provides a toilet cleaning block, comprising perfume, at least one alkylbenzene sulfonate and at least one olefin sulfonate, which comprises no more than 2.5 wt. % nonionic surfactants and which can be shaped in a rolling machine or press to form a rotationally symmetrical object. In particular, the manufacture of spherical toilet cleaning blocks with high sphericity is possible.

The toilet cleaning block according to the invention is generally employed in a dispensing device, such as a so-called rim block cage. This invention therefore also provides a system composed of at least one toilet cleaning block according to the invention and a dispensing device.

The toilet cleaning block according to the invention can be manufactured in a method that encompasses the steps of mixing the ingredients, extruding the mixture, cutting the extruded strand into pieces of a defined mass and shaping into rotationally symmetrical objects.

The invention therefore also provides a method of manufacturing a rotationally symmetrical toilet cleaning block, which comprises perfume, nonionic surfactant, alkylbenzene sulfonate and olefin sulfonate, encompassing the steps of

a) mixing the ingredients,

b) extruding the mixture,

c) cutting the extruded strand into pieces of a defined mass,

d) shaping into rotationally symmetrical objects.

The system according to the invention composed of the toilet cleaning block and the dispensing device can additionally be used in a method for cleaning and/or perfuming and/or disinfecting flush toilets in that the dispensing device filled with the toilet cleaning block is suspended in the toilet bowl and, when the toilet is flushed, dissolved ingredients in the toilet cleaning block enter the flushing water and can develop their cleaning and/or perfuming and/or disinfecting action there.

The invention therefore also provides a method for cleaning and/or perfuming and/or disinfecting flush toilets using a system composed of a toilet cleaning block according to the invention and a dispensing device.

Substances which also act as ingredients in cosmetic agents may be referred to below according to the International Nomenclature of Cosmetic Ingredients (INCI) nomenclature. Chemical compounds have an INCI name in English, plant ingredients are listed exclusively in Latin by the Linne system, and so-called trivial names, such as “water”, “honey” or “sea salt”, are also given in Latin. The INCI names can be taken from the International Cosmetic Ingredient Dictionary and Handbook—Seventh Edition (1997), which is published by The Cosmetic, Toiletry, and Fragrance Association (CTFA), 1101 17th Street, NW, Suite 300, Washington, D.C. 20036, USA, and contains more than 9,000 INCI names as well as references to more than 37,000 trade names and technical names, including the associated distributors in more than 31 countries. The International Cosmetic Ingredient Dictionary and Handbook assigns the ingredients to one or more chemical classes, e.g. Polymeric Ethers, and one or more functions, e.g. Surfactants—Cleansing Agents, which define them in more detail and to which reference may also be made below.

References to CAS mean that the subsequent series of figures are a Chemical Abstracts Service name.

Within the framework of the present invention, fatty acids or fatty alcohols or derivatives thereof—unless otherwise specified—represent branched or unbranched carboxylic acids or alcohols or derivatives thereof with preferably 6 to 22 carbon atoms, in particular 8 to 20 carbon atoms, particularly preferably 10 to 18 carbon atoms, extremely preferably 12 to 16 carbon atoms, e.g. 12 to 14 carbon atoms. The former are preferred for ecological reasons, particularly because they are plant-based and therefore based on sustainable raw materials, but without limiting the teaching of the invention thereto. In particular, the oxo alcohols or derivatives thereof, which are obtainable e.g. by ROELEN's oxo synthesis, with preferably 7 to 19 carbon atoms, in particular 9 to 19 carbon atoms, particularly preferably 9 to 17 carbon atoms, extremely preferably 11 to 15 carbon atoms, e.g. 9 to 11, 12 to 15 or 13 to 15 carbon atoms, can be used accordingly.

### Perfume

The agent comprises one or more scents, preferably in a quantity of 0.01 to 10 wt. %, in particular 0.05 to 8 wt. %, particularly preferably 0.1 to 5 wt. %. As a perfume component here, d-limonene can be comprised. In a particularly preferred embodiment, the toilet cleaning block according to the invention comprises a perfume composed of essential oils (also known as ethereal oils). For example, pine, citrus, jasmine, patchouli, rose or ylang-ylang oil can be used within the meaning of this invention as such an oil. Also suitable are clary sage oil, chamomile oil, lavender oil, clove oil, melissa oil, mint oil, cinnamon leaf oil, linden blossom oil, juniper berry oil, vetiver oil, olibanum oil, galbanum oil and labdanum oil as well as orange blossom oil, neroli oil, orange peel oil and sandalwood oil.

In order to be perceptible, a fragrance must be volatile, the molar mass playing an important part in this together with the nature of the functional groups and the structure of the chemical compound. Thus, most fragrances have molar masses of up to about 200 daltons while molar masses of 300 daltons and above are more of an exception. Owing to the different volatility of fragrances, the odor of a perfume composed of several fragrances changes during evaporation, the odor impressions being categorized as “top note”, “middle note or body” and “end note or dry out”.

Tenacious fragrances which can be used advantageously in the perfume oils within the framework of the present invention are e.g. the essential oils, such as angelica root oil, anise oil, arnica flower oil, basil oil, bay oil, champaca flower oil, silver fir oil, silver fir cone oil, elemi oil, eucalyptus oil, fennel oil, spruce needle oil, galbanum oil, geranium oil, ginger grass oil, guaiacwood oil, gurjun balsam oil, helichrysum oil, ho oil, ginger oil, iris oil, cajeput oil, calamus oil, chamomile oil, camphor oil, cananga oil, cardamom oil, cassia oil, pine needle oil, copaiba balsam oil, coriander oil, spearmint oil, caraway oil, cumin oil, lemongrass oil, musk seed oil, myrrh oil, clove oil, neroli oil, niaouli oil, olibanum oil, oregano oil, palmarosa oil, patchouli oil, Peru balsam oil, petitgrain oil, pepper oil, peppermint oil, pimento oil, pine oil, rosemary oil, sandalwood oil, celery oil, star anise oil, thuja oil, thyme oil, verbena oil, vetiver oil, juniper berry oil, wormwood oil, wintergreen oil, ylang-ylang oil, hyssop oil, cinnamon oil, cinnamon leaf oil and cypress oil.

However, the higher-boiling or solid fragrances of natural or synthetic origin can also be used advantageously in the perfume oils within the framework of the present invention as tenacious fragrances or fragrance mixtures. These compounds include the compounds mentioned below and mixtures thereof: ambrettolide, α-amyl cinnamaldehyde, anethole, anisaldehyde, anisyl alcohol, anisole, anthranilic acid methyl ester, acetophenone, benzyl acetone, benzaldehyde, benzoic acid ethyl ester, benzophenone, benzyl alcohol, borneol, bornyl acetate, α-bromostyrene, n-decyl aldehyde, n-dodecyl aldehyde, eugenol, eugenol methyl ether, eucalyptol, farnesol, fenchone, fenchyl acetate, geranyl acetate, geranyl formate, heliotropin, heptyne carboxylic acid methyl ester, heptaldehyde, hydroquinone dimethyl ether, hydroxycinnamaldehyde, hydroxycinnamyl alcohol, indole, irone, isoeugenol, isoeugenol methyl ether, isosafrole, jasmone, camphor, carvacrol, carvone, p-cresol methyl ether, coumarin, p-methoxyacetophenone, methyl-n-amyl ketone, methylanthranilic acid methyl ester, p-methyl acetophenone, methyl chavicol, p-methyl quinoline, methyl-β-naphthyl ketone, methyl-n-nonyl acetaldehyde, methyl-n-nonyl ketone, muscone, β-naphthol ethyl ether, β-naphthol methyl ether, nerol, nitrobenzene, n-nonyl aldehyde, nonyl alcohol, n-octyl aldehyde, p-oxyacetophenone, pentadecanolide, β-phenylethyl alcohol, phenylacetaldehyde dimethyl acetal, phenylacetic acid, pulegone, safrole, salicylic acid isoamyl ester, salicylic acid methyl ester, salicylic acid hexyl ester, salicylic acid cyclohexyl ester, santalol, skatole, terpineol, thymene, thymol, γ-undecalactone, vanillin, veratrum aldehyde, cinnamaldehyde, cinnamyl alcohol, cinnamic acid, cinnamic acid ethyl ester and cinnamic acid benzyl ester.

The more volatile fragrances which can be used advantageously in the perfume oil within the framework of the present invention include in particular the lower boiling fragrances of natural or synthetic origin, which can be used individually or in mixtures. Examples of more volatile fragrances are alkyl isothiocyanates (alkyl mustard oils), butanedione, limonene, linalool, linalyl acetate, linalyl propionate, menthol, menthone, methyl-n-heptenone, phellandrene, phenylacetaldehyde, terpinyl acetate, citral and citronellal.

### Surfactants

The toilet cleaning block according to the invention comprises at least one alkylbenzene sulfonate and at least one olefin sulfonate. In addition, other surfactants, in particular anionic surfactants, can be comprised.

Among the alkylbenzene sulfonates, in particular those with about 12 C atoms in the alkyl portion are preferred, for instance linear sodium C₁₀₋₁₃ alkylbenzene sulfonate. Preferred olefin sulfonates have a carbon chain length of 14 to 16. The toilet cleaning block according to the invention preferably comprises 10 to 70 wt. %, for preference 20 to 65 wt. %, particularly preferably 20 to 30 wt. % alkylbenzene sulfonate and preferably 10 to 30 wt. %, for preference 15 to 30 wt. %, particularly preferably 15 to 25 wt. % olefin sulfonate.

### Further Anionic Surfactants

As further anionic surfactants, aliphatic sulfates, such as fatty alcohol sulfates, fatty alcohol ether sulfates, dialkyl ether sulfates, monoglyceride sulfates, and aliphatic sulfonates, such as alkane sulfonates, ether sulfonates, n-alkyl ether sulfonates, ester sulfonates and lignin sulfonates, can be in the toilet cleaning block according to the invention. Likewise within the framework of the present invention, fatty acid cyanamides, sulfosuccinates (sulfosuccinic acid esters), in particular sulfosuccinic acid mono- and di-C₈-C₁₈-alkyl esters, sulfosuccinamates, sulfosuccinamides, fatty acid isethionates, acylaminoalkane sulfonates (fatty acid taurides), fatty acid sarcosinates, ether carboxylic acids and alkyl (ether) phosphates as well as α-sulfo fatty acid salts, acyl glutamates, monoglyceride disulfates and alkyl ethers of glycerol disulfate can be used.

Within the framework of the present invention, the fatty alcohol sulfates and/or fatty alcohol ether sulfates are preferred, in particular the fatty alcohol sulfates. Fatty alcohol sulfates are products of sulfation reactions of appropriate alcohols, while fatty alcohol ether sulfates are products of sulfation reactions of alkoxylated alcohols. The person skilled in the art understands alkoxylated alcohols in general to be the reaction products of alkylene oxide, preferably ethylene oxide, with alcohols, within the meaning of the present invention preferably with longer-chain alcohols. In general, from n moles of ethylene oxide and one mole of alcohol, depending on the reaction conditions, a complex mixture of addition products with different degrees of ethoxylation is formed. Another embodiment of alkoxylation consists in the use of mixtures of alkylene oxides, preferably of the mixture of ethylene oxide and propylene oxide. Preferred fatty alcohol ether sulfates are the sulfates of fatty alcohols with a low degree of ethoxylation, having 1 to 4 ethylene oxide units (EO), in particular 1 to 2 EO, e.g. 1.3 EO. In a preferred embodiment, the toilet cleaning block according to the invention comprises at least one fatty alcohol sulfate in a quantity of up to 20 wt. %, preferably 4 to 12 wt. %, particularly preferably 7 to 10 wt. %.

The anionic surfactants are preferably used as sodium salts, but can also be comprised as other alkali or alkaline earth metal salts, e.g. magnesium salts, as well as in the form of ammonium or mono-, di-, tri- or tetraalkylammonium salts, and in the case of the sulfonates also in the form of their corresponding acid, e.g. dodecylbenzenesulfonic acid.

### Nonionic Surfactants

For reasons of processability, it may be desirable for the toilet cleaning block according to the invention also to comprise nonionic surfactant. Suitable nonionic surfactants within the framework of this invention are alkoxylates, such as polyglycol ethers, fatty alcohol polyglycol ethers, alkylphenol polyglycol ethers, end-capped polyglycol ethers, mixed ethers and hydroxy mixed ethers and fatty acid polyglycol esters. Also suitable are block polymers of ethylene oxide and propylene oxide as well as fatty acid alkanolamides and fatty acid polyglycol ethers. Other important classes of nonionic surfactants that can be used according to the invention are the amine oxides and the sugar surfactants, in particular the alkyl polyglucosides.

The toilet cleaning block according to the invention comprises no more than 2.5 wt. % nonionic surfactants, advantageously those in particulate form. This is particularly important in the formulation of toilet cleaning blocks with chlorine-containing disinfectants, since these two components can react with one another. In a preferred embodiment, the toilet cleaning block according to the invention is free from nonionic surfactants.

In addition to the above-mentioned types of surfactants, the agent according to the invention can also comprise cationic surfactants and/or amphoteric surfactants.

Suitable amphoteric surfactants are e.g. betaines of the formula (Rⁱⁱⁱ)(R^{iv})(R^{v})N⁺CH₂COO⁻, in which Rⁱⁱⁱ signifies an alkyl residue optionally interrupted by heteroatoms or heteroatom groups with 8 to 25, preferably 10 to 21 carbon atoms and R^{iv} and R^{v} signify the same or different types of alkyl residue with 1 to 3 carbon atoms, in particular C₁₀-C₁₈ alkyldimethyl carboxymethylbetaine and C₁₁-C₁₇ alkylamidopropyldimethyl carboxymethylbetaine.

Suitable cationic surfactants are inter alia the quaternary ammonium compounds of the formula (R^{vi})(R^{vii})(R^{viii})(R^{ix})N⁺X⁻, in which R^{vi} to R^{ix} denote four similar or different, in particular two long- and two short-chain, alkyl residues and X⁻ denotes an anion, in particular a halide ion, e.g. didecyldimethylammonium chloride, alkylbenzyldidecylammonium chloride and mixtures thereof. Quaternary ammonium compounds with an antimicrobial action are preferred. In a particularly preferred embodiment, the toilet cleaning block according to the invention is free from cationic surfactants, however.

### Antimicrobial Active Ingredients

A particular form of cleaning is represented by disinfection and sanitation. In a corresponding particular embodiment of the invention, the toilet cleaning block therefore comprises one or more antimicrobial active ingredients, preferably in a quantity of up to 40 wt. %, for preference 0.01 to 25 wt. %, in particular 0.1 to 5 wt. %.

The terms disinfection, sanitation, antimicrobial action and antimicrobial active ingredient within the framework of the teaching according to the invention have the conventional technical meaning. While disinfection in the narrower sense of medical practice means the killing of—theoretically all—infectious microbes, sanitation is to be understood as the elimination of all microbes, as far as possible—even the saprophytic microbes which are normally harmless to humans. The extent of the disinfection or sanitation here depends on the antimicrobial action of the agent used, which decreases with a decreasing content of antimicrobial active ingredient or an increasing dilution of the agent for application.

Suitable according to the invention are e.g. antimicrobial active ingredients from the groups of the alcohols, aldehydes, antimicrobial acids or salts thereof, carboxylic acid esters, acid amides, phenols, phenol derivatives, diphenyls, diphenyl alkanes, urea derivatives, oxygen and nitrogen acetals and formals, benzamidines, isothiazoles and derivatives thereof, such as isothiazolines and isothiazolinones, phthalimide derivatives, pyridine derivatives, antimicrobial surface-active compounds, guanidines, antimicrobial amphoteric compounds, quinolines, 1,2-dibromo-2,4-dicyanobutane, iodo-2-propynyl butylcarbamate, iodine, iodophors, compounds releasing active chlorine and peroxides. Preferred antimicrobial active ingredients are preferably selected from the group encompassing 1,3-butanediol, phenoxyethanol, 1,2-propylene glycol, glycerol, undecylenic acid, citric acid, lactic acid, benzoic acid, salicylic acid, thymol, 2-benzyl-4-chlorophenol, 2,2′-methylenebis(6-bromo-4-chlorophenol), 2,4,4′-trichloro-2′-hydroxydiphenyl ether, N-(4-chlorophenyl)-N-(3,4-dichlorophenyl)urea, N,N′-(1,10-decanediyldi-1-pyridinyl-4-ylidene)bis(1-octanamine) dihydrochloride, N,N-bis(4-chlorophenyl)-3,12-diimino-2,4,11,13-tetraazatetradecanediimidamide, antimicrobial quaternary surface-active compounds, guanidines, trichloroisocyanuric acid and sodium dichloroisocyanurate (DCI, 1,3-dichloro-5H-1,3,5-triazine-2,4,6-trione sodium salt). Preferred antimicrobially active quaternary compounds comprise an ammonium, sulfonium, phosphonium, iodonium or arsonium group. Furthermore, antimicrobially active essential oils can also be used, which at the same time provide perfuming of the cleaning agent. However, particularly preferred antimicrobial active ingredients are selected from the group encompassing salicylic acid, quaternary surfactants, in particular benzalkonium chloride, peroxo compounds, in particular sodium percarbonate or phthalimidoperoxyhexanoic acid, alkali metal hypochlorite, trichloroisocyanuric acid, sodium dichloroisocyanurate and mixtures thereof. Most particularly preferably, the toilet cleaning block according to the invention comprises sodium dichloroisocyanurate.

### Other Ingredients

In addition to the above-mentioned components, the toilet cleaning block according to the invention can comprise other ingredients that are conventionally used in toilet cleaning blocks, preferably selected from the group encompassing acids, bases, salts, thickeners, preservatives, complexing agents, polymers, dyes, scents, perfume boosters, fillers, builders, bleaching agents, corrosion inhibitors, flush regulators, enzymes, microorganisms, active ingredients for biofilm removal, active ingredients for inhibiting limescale deposits, active ingredients for reducing soil adhesion, active ingredients for improving processability, active ingredients for reducing tack and mixtures thereof. In total, no more than 60 wt. % of other ingredients should be comprised, preferably 0.01 to 60 wt. %, in particular 0.2 to 15 wt. %.

### Acids

Toilet cleaning blocks according to the invention can comprise one or more acids and/or salts thereof to enhance the cleaning performance towards limescale and urine scale. The acids are preferably made from sustainable raw materials. Suitable as acids are therefore in particular organic acids, such as acetic acid, citric acid, glycolic acid, lactic acid, succinic acid, adipic acid, malic acid, tartaric acid and gluconic acid as well as mixtures thereof. In addition, however, amidosulfonic acid can also be used. Particularly preferred are the acids and/or salts thereof selected from the group encompassing citric acid, lactic acid, amidosulfonic acid, salts thereof and mixtures thereof. They are preferably used in quantities of 0.01 to 10 wt. %, particularly preferably 0.2 to 5 wt. %. In a most particularly preferred embodiment, however, the toilet cleaning block according to the invention is free from acids.

In addition, in a preferred embodiment, the agent comprises inorganic salts, preferably alkali or alkaline earth metal salts, in particular carbonates, sulfates, halides or phosphates as well as mixtures thereof. Sodium sulfate and/or sodium carbonate are particularly preferably used. Sodium sulfate can be comprised in a quantity of up to 60 wt. %, preferably 0.01 to 60 wt. %, particularly preferably 20 to 60 wt. %, in particular 35 to 55 wt. %. Sodium carbonate and other salts can be comprised in a quantity of up to 30 wt. %, preferably up to 10 wt. %, particularly preferably up to 5 wt. %.

### Bases

Alkalis can also be comprised in agents according to the invention. As bases in agents according to the invention, preferably those from the group of the alkali and alkaline earth metal hydroxides and carbonates are used, in particular sodium carbonate or sodium hydroxide. In addition, however, it is also possible to use ammonia and/or alkanolamines with up to 9 C atoms in the molecule, preferably the ethanolamines, in particular monoethanolamine.

### Preservatives

Preservatives can likewise be comprised in toilet cleaning blocks according to the invention. Substantially the substances mentioned in the antimicrobial active ingredients can be used as preservatives.

### Complexing Agents

Complexing agents (INCI Chelating Agents), also known as sequestering agents, are ingredients which are capable of complexing and inactivating metal ions to prevent their disadvantageous effects on the stability or appearance of the agents, e.g. haze. On the one hand, it is important to complex the calcium and magnesium ions from the water hardness which are incompatible with numerous ingredients. The complexing of the ions of heavy metals such as iron or copper, on the other hand, delays the oxidative decomposition of the finished agents. In addition, complexing agents support the cleaning action.

The following complexing agents named in accordance with INCI are suitable examples:

Aminotrimethylene Phosphonic Acid, Beta-Alanine Diacetic Acid, Calcium Disodium EDTA, Citric Acid, Cyclodextrin, Cyclohexanediamine Tetraacetic Acid, Diammonium Citrate, Diammonium EDTA, Diethylenetriamine Pentamethylene Phosphonic Acid, Dipotassium EDTA, Disodium Azacycloheptane Diphosphonate, Disodium EDTA, Disodium Pyrophosphate, EDTA, Etidronic Acid, Galactaric Acid, Gluconic Acid, Glucuronic Acid, HEDTA, Hydroxypropyl Cyclodextrin, Methyl Cyclodextrin, Pentapotassium Triphosphate, Pentasodium Aminotrimethylene Phosphonate, Pentasodium Ethylenediamine Tetramethylene Phosphonate, Pentasodium Pentetate, Pentasodium Triphosphate, Pentetic Acid, Phytic Acid, Potassium Citrate, Potassium EDTMP, Potassium Gluconate, Potassium Polyphosphate, Potassium Trisphosphonomethylamine Oxide, Ribonic Acid, Sodium Chitosan Methylene Phosphonate, Sodium Citrate, Sodium Diethylenetriamine Pentamethylene Phosphonate, Sodium Dihydroxyethylglycinate, Sodium EDTMP, Sodium Gluceptate, Sodium Gluconate, Sodium Glycereth-1 Polyphosphate, Sodium Hexametaphosphate, Sodium Metaphosphate, Sodium Metasilicate, Sodium Phytate, Sodium Polydimethylglycinophenolsulfonate, Sodium Trimetaphosphate, TEA-EDTA, TEA-Polyphosphate, Tetrahydroxyethyl Ethylenediamine, Tetrahydroxypropyl Ethylenediamine, Tetrapotassium Etidronate, Tetrapotassium Pyrophosphate, Tetrasodium EDTA, Tetrasodium Etidronate, Tetrasodium Pyrophosphate, Tripotassium EDTA, Trisodium Dicarboxymethyl Alaninate, Trisodium EDTA, Trisodium HEDTA, Trisodium NTA and Trisodium Phosphate.

### Polymers

The toilet cleaning block according to the invention can additionally comprise polymers. These can be used e.g. to reduce limescale formation and the propensity to resoiling.

In this regard, preferred polymers are acrylic polymers, such as those commercially available from Rhodia with the trade name Mirapol.

### Scents and Dyes

As other ingredients, the toilet cleaning block according to the invention can comprise one or more scents and/or one or more dyes (INCI Colorants). As dyes, both water-soluble and oil-soluble dyes can be used here, on the one hand taking into account their compatibility with other ingredients, e.g. bleaching agents, and on the other hand the dye used should not have a substantive effect on the toilet ceramic, even with prolonged exposure. The dyes are preferably comprised in a quantity of 0.0001 to 0.1 wt. %, in particular 0.0005 to 0.05 wt. %, particularly preferably 0.001 to 0.01 wt. %.

### Builders

Water-soluble and/or water-insoluble builders may optionally be used in the toilet cleaning blocks according to the invention. Water-soluble builders are preferred here, since they generally have a lower tendency to leave behind insoluble residues on hard surfaces. Conventional builders which can be present within the framework of the invention are low molecular weight polycarboxylic acids and their salts, homopolymeric and copolymeric polycarboxylic acids and their salts, citric acid and its salts, carbonates, phosphates and silicates. Water-insoluble builders include the zeolites, which can also be used, as can mixtures of the aforementioned builder substances.

### Bleaching Agents

According to the invention, bleaching agents can be added to the cleaning agent. Suitable bleaching agents encompass peroxides, per acids and/or perborates; sodium percarbonate or phthalimidoperoxyhexanoic acid are particularly preferred. Chlorine-containing bleaching agents, such as trichloroisocyanuric acid or sodium dichloroisocyanurate, on the other hand, are less suitable in acidically formulated cleaning agents owing to the release of toxic chlorine gas vapors, but can be used in alkaline cleaning agents. In certain circumstances, a bleach activator may be needed as well as the bleaching agent.

### Corrosion Inhibitors

Suitable corrosion inhibitors (INCI Corrosion Inhibitors) are e.g. the following substances named in accordance with INCI: Cyclohexylamine, Diammonium Phosphate, Dilithium Oxalate, Dimethylamino Methylpropanol, Dipotassium Oxalate, Dipotassium Phosphate, Disodium Phosphate, Disodium Pyrophosphate, Disodium Tetrapropenyl Succinate, Hexoxyethyl Diethylammonium, Phosphate, Nitromethane, Potassium Silicate, Sodium Aluminate, Sodium Hexametaphosphate, Sodium Metasilicate, Sodium Molybdate, Sodium Nitrite, Sodium Oxalate, Sodium Silicate, Stearamidopropyl Dimethicone, Tetrapotassium Pyrophosphate, Tetrasodium Pyrophosphate and Triisopropanolamine.

### Flush Regulators

The substances referred to as flush regulators are used primarily to control the consumption of the agents during use in such a way that the planned life span is achieved. Suitable as regulators are preferably solid long-chain fatty acids, such as stearic acid, but also salts of these fatty acids, fatty acid ethanolamides, such as coconut fatty acid monoethanolamide, or solid polyethylene glycols, such as those with molecular weights of between 10000 and 50000.

### Active Ingredients for Reducing Tack

To improve processability, an active ingredient for reducing tack can be added during manufacture of the toilet cleaning block according to the invention. For instance, adding dolomite powder or titanium dioxide powder with a fine particle size distribution improves the processing behavior when forming the spheres, and significantly reduces abrasion or tack.

The results with such active ingredients are better than with other conventional measures, for example coating the spheres with a lubricant, dusting or coating the shaping rollers with Teflon.

### Enzymes

The agent can also comprise enzymes, preferably proteases, lipases, amylases, hydrolases and/or cellulases. These can be added to the agent according to the invention in any form which is established according to the prior art. These include solutions of the enzymes, which are advantageously as concentrated as possible, low in water and/or with added stabilizers. Alternatively, the enzymes can be encapsulated, for example by spray drying or extrusion of the enzyme solution together with a preferably natural polymer or in the form of capsules, for example those in which the enzyme is embedded as in a solidified gel, or in those of the core-shell type, in which an enzyme-containing core is coated with a water-, air- and/or chemical-impervious protective layer. Further active ingredients, for example stabilizers, emulsifiers, pigments, bleaches or dyes, can also be applied in additional layers. Such capsules are made using known methods, for example by vibratory granulation or roll compaction or by fluidized bed processes. Advantageously, these types of granules are low in dust, for example by applying polymeric film formers, and are storage stable as a result of the coating.

In addition, enzyme stabilizers can be present in enzyme-containing agents in order to protect an enzyme comprised in an agent according to the invention against damage, such as e.g. inactivation, denaturing or decomposition, for instance by physical effects, oxidation or proteolytic cleavage. Depending on the enzyme used in each case, the following are particularly suitable as enzyme stabilizers: benzamidine hydrochloride, borax, boric acids, boronic acids or their salts or esters, primarily derivatives having aromatic groups, for example substituted phenylboronic acids or their salts or esters; peptide aldehydes (oligopeptides with reduced C-terminus), amino alcohols, such as mono-, di-, triethanolamine and mono-, di-, tripropanolamine and mixtures thereof, aliphatic carboxylic acids up to C₁₂, such as succinic acid, other dicarboxylic acids or salts of the above acids, end-capped fatty acid amide alkoxylates; aliphatic lower alcohols and primarily polyols, for example glycerol, ethylene glycol, propylene glycol or sorbitol, as well as reducing agents and antioxidants, such as sodium sulfite and reducing sugars. Other suitable stabilizers are known from the prior art. The use of combinations of stabilizers is preferred, for example the combination of polyols, boric acid and/or borax, the combination of boric acid or borate, reducing salts and succinic acid or other dicarboxylic acids or the combination of boric acid or borate with polyols or polyamino compounds and with reducing salts.

### Multi-Layer Toilet Cleaning Blocks

It is known from the prior art, for example EP 791047B1, to manufacture toilet cleaning blocks from materials of different compositions, wherein one of the materials is totally or partially encapsulated by the other material(s). Thus, for example, the inner material can possess a higher perfume concentration than the outer material in order to ensure a constant fragrance impression with a diminishing sphere weight over the service life of the product, or the inner material may comprise a different fragrance than the outer material. In addition, other active ingredients can also be incorporated in different layers such that they are released at different times depending on the extent of flushing. This type of layered construction is also possible for the toilet cleaning block according to the invention.

### Sphericity

The toilet cleaning block preferably has a sphericity of between 0.8 and 1, particularly preferably between 0.85 and 1, most particularly preferably between 0.9 and 1.

The sphericity Ψ of an object K is the ratio of the surface area of the object to the surface area of a sphere of the same volume:

$$Ψ = \frac{{{π}^{\frac{1}{3}} ( 6 {V}_{p} )}^{\frac{2}{3}}}{{A}_{p}} ,$$

where Vₚ is the volume of the object and Aₚ is its surface area.

Having almost a perfect spherical shape for the toilet cleaning block results in the toilet cleaning block being flushed away evenly, such that the toilet cleaning block substantially maintains its ball shape, even during and after the flush processes and a corresponding erosion of the toilet cleaning block. It has been shown that a high sphericity Ψ of the toilet cleaning block prior to the impact of the flushing water is particularly important for the maintenance of the ball shape during and after the flush processes. The formability of the material, and thus its capacity to be optimally rounded, can be adjusted by adding a small quantity of liquid. In particular water, dipropylene glycol or paraffin can be used as liquids in a quantity of 0.1 to 1 wt. %.

The diameter of the spherical toilet block is for preference between 1 mm and 10 cm, preferably between 5 mm and 5 cm and particularly preferably between 1 cm and 3 cm.

The toilet cleaning block is inserted into a dispensing device that is fixed on the rim of the toilet bowl with a holder. On the one hand, cages with a flushing water distribution element are suitable for this, as already described in the prior art, for example in DE 102008037723, which can receive one or more toilet cleaning blocks. On the other hand, one or more open plates can be used, onto which one or more toilet cleaning blocks are appropriately fixed. The toilet cleaning block according to the invention and the dispensing device together form a system. This can accordingly be employed in a method for cleaning and/or perfuming and/or disinfecting flush toilets in that the dispensing device filled with the toilet cleaning block is suspended in the toilet bowl and when the toilet is flushed, dissolved ingredients of the toilet cleaning block enter the flushing water and can develop their cleaning and/or perfuming and/or disinfecting action there. Corresponding systems are described in DE 102009003088.

The toilet cleaning block according to the invention is manufactured in a method which encompasses the steps of

a) mixing the ingredients,

b) extruding the mixture a) into an extruded strand,

c) cutting the extruded strand into pieces of a defined mass,

d) shaping the pieces into rotationally symmetrical objects.

The shaping d) preferably takes place in a ball rolling machine or press. Other suitable shaping methods are casting and calendering. Steps a) and b) can also be combined, i.e. mixing the ingredients in the extruder. The steps optionally take place at different temperatures, so that heating or cooling steps can be inserted between the steps. These are at the discretion of the person skilled in the art.

In a preferred embodiment, an additional step is carried out following one of steps b) or c), in which the extruded strand is provided with a lubricant. For this purpose, a sponge in the form of a wheel which is permanently charged with the lubricant is guided over the extruded strand such that the surface is completely or partially covered with lubricant, preferably to a level of 10 to 40%. The addition of the lubricant here improves the subsequent shaping into a sphere.

Suitable alternatives to the use of a sponge for lubricating the strand are e.g. simply dropping or spraying, as well as dipping wheels, dipping baths for strips or strands etc. Different methods can also be combined, such as dipping a wheel through a lubricant bath and then rolling it along the strand combined with dropping.

As well as the extruded strand, the rolls can also be provided with the lubricant.

Suitable lubricants are in particular substances that are used e.g. as surfactants or flush regulators in formulations according to the invention. Particularly preferred is a lubricant selected from the group encompassing dipropylene glycol, paraffins, nonionic surfactants, polyethylene glycols and mixtures thereof, in particular dipropylene glycol.

It is particularly preferred if the toilet cleaning block is shaped into a ball with a sphericity IP of between 0.8 and 1, particularly preferably between 0.85 and 1, most particularly preferably between 0.9 and 1.

### Exemplary Embodiments

Three toilet cleaning blocks according to the invention were produced with the formulations E1 to E4 as well as a comparative formulation V1. The compositions can be taken from the following table, wherein all quantitative data are given in wt. % of the active substance.

| | E1 | E2 | E3 | E4 | V1 |
|---|---|---|---|---|---|
| C₁₀₋₁₃ lin. alkylbenzene sulfonate Na | 10 | 22 | 19 | 10 | 26 |
| C₁₄₋₁₆ olefin sulfonate Na | 20 | 10 | 10 | 20 | 18 |
| C₁₂ fatty alcohol sulfate Na | 10 | 9 | 10 | 7 | — |
| Sodium dichloroisocyanurate 2-hydrate | 3.2 | 2.5 | 3.0 | 2 | 14.4 |
| Trisodium citrate dihydrate | 1.0 | 2.0 | 1.0 | 1 | 1 |
| Cellulose | — | — | 1.0 | — | — |
| Sodium silicate | — | — | 5.0 | — | — |
| Sodium carbonate | — | 1.0 | — | — | — |
| Perfume | 4.0 | 4.0 | 4.0 | 4 | 4.5 |
| Titanium dioxide | 0.5 | — | — | 0.5 | — |
| C₁₆₋₁₈ fatty alcohol ethoxylate 25 EO | — | — | — | 2 | 8 |
| Paraffin oil, low-viscosity | — | — | — | 1 | — |
| Sodium sulfate | to 100 | to 100 | to 100 | to 100 | to 100 |

The nonionic surfactant content in the comparative formulation, which was too high, led to a marked reduction in the chlorine content. Immediately after production, the content had already fallen to 9.7% and after a period of use of 48 hours and 43 flushes, 3.4% of the chlorine carrier could be detected. The formulations according to the invention, on the other hand, exhibited smaller decreases in chlorine content, even in the case of formulation E4, which had a low nonionic surfactant content.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A toilet cleaning block comprising perfume, at least one alkylbenzene sulfonate and at least one olefin sulfonate, wherein the block comprises one or more antimicrobial active ingredients and no more than 2.5 wt % nonionic surfactants and wherein the block is in the form of a spherical object.

2. The toilet cleaning block according to claim 1 comprising 10 to 70 wt. % alkylbenzene sulfonate.

3. The toilet cleaning block according to claim 1 comprising 10 to 30 wt. % olefin sulfonate.

4. The toilet cleaning block according to claim 1 further comprising at least one additional anionic surfactant.

5. The toilet cleaning block according to claim 4, wherein the at least one additional anionic surfactant is a fatty alcohol sulfate at a level of up to 20 wt. %.

6. The toilet cleaning block according to claim 1, wherein it is free from nonionic surfactants.

7. The toilet cleaning block according to claim 1, further comprising at least one additional surfactant selected from the group consisting of fatty alcohol ether sulfates, alkane sulfonates and mixtures thereof.

8. The toilet cleaning block according to claim 1, wherein the antimicrobial active ingredient or ingredients are selected from the group consisting of salicylic acid, quaternary surfactants, peroxo compounds, alkali metal hypochlorite, sodium dichloroisocyanurate and mixtures thereof.

9. The toilet cleaning block according to claim 1, wherein it comprises one or more further ingredients conventionally used in toilet cleaning blocks selected from the group encompassing acids, bases, salts, thickeners, preservatives, complexing agents, dyes, scents, perfume boosters, fillers, builders, bleaching agents, corrosion inhibitors, flush regulators, enzymes, microorganisms, active ingredients for biofilm removal, active ingredients for inhibiting timescale deposits, active ingredients for reducing soil adhesion and mixtures thereof.

10. The toilet cleaning block according to claim 1, wherein the toilet cleaning block has the shape of a ball with a sphericity Ψ of between 0.8 and 1.

11. A system of at least one toilet cleaning block according to claim 1 and a dispensing device.

12. A method of manufacturing a rotationally symmetrical toilet cleaning block, the ingredients of which comprise perfume, alkylbenzene sulfonate and olefin sulfonate and is free from nonionic surfactants, comprising the steps of:
a) mixing the ingredients,
b) extruding the mixture a) into an extruded strand,
c) cutting the extruded strand into pieces of a defined mass,
d) shaping the pieces into rotationally symmetrical objects.

13. The method according to claim 12, wherein following one of steps b) or c) the extruded strand is provided with a lubricant.

14. The method according to claim 12, wherein the shaping d) takes place in a ball rolling machine or in a press.

15. A method for cleaning and/or perfuming and/or disinfecting flush toilets using a system according to claim 11.
